(19) United States
(12) Patent Application Publication
(10) Pub. No.: US 2019/0066115 A1
(43) Pub. Date: Feb. 28, 2019

(54) CALCULATION OF BENCHMARK DISPUTE OVERAGE AND REJECTION DATA WITH REDRESS OPTIONS

(71) Applicant: Coupa Software Incorporated, San Mateo, CA (US)

(72) Inventors: Scott Harris, Menlo Park, CA (US); Justin Mehta, Belmont, CA (US); Andrew Miller, San Mateo, CA (US)

(21) Appl. No.: 15/683,689

(22) Filed: Aug. 22, 2017

(51) Int. Cl. G06Q 30/00

(52) U.S. Cl. CPC G06Q 30/01

(57) ABSTRACT

In an embodiment, a computer-implemented method comprises receiving, at a server computing instance, external rating data and profile data for a particular supplier entity of a plurality of supplier entities from one or more external data sources; storing, in one or more data repositories, supplier rating data values associated with the particular supplier entity, the supplier rating data values generated by a plurality of buyer entities who rated the particular supplier entity; storing, in one or more data repositories, first transactional information for the particular supplier entity, the first transactional information relating to past transactions between a particular buyer entity of the plurality of buyer entities and the particular supplier entity; storing, in one or more data repositories, second transactional information for the particular supplier entity, the second transactional information relating to past transactions between a plurality of buyer entities and the particular supplier entity; calculating a health score value for the particular supplier entity based at least in part on the external rating data and profile data for the particular supplier entity, the supplier rating data values associated with the particular supplier entity, and at least in part on comparing one or more metrics in the first transactional information to one or more metrics in the second transactional information; generating and causing displaying, at a computer associated with the buyer entity, a digital data display that indicates the health score value of the particular supplier entity.

### FIELD OF THE DISCLOSURE

The present disclosure is generally related to improvements in computer-based enterprise procurement systems, and specifically relates to techniques for calculating metrics that represent supplier entity health based on large scale transactional data, for use as a foundation in recommending substitute suppliers and/or increasing computer efficiency by directing more transactions to the same supplier computers.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Business enterprises use computer-based electronic procurement systems to manage creating, reviewing, approving, and communicating requests (or “requisitions”) to purchase items, goods, or services from suppliers and/or vendors. In a typical electronic procurement environment, buyers (or “buyer entities”) are free to choose from a variety of suppliers (or “supplier entities”) to engage in transactions with. A buyer will select a supplier to transact with based on a variety of factors. For example, a buyer may select a supplier based on previous dealing experience with the specific supplier, the reputation of the specific supplier, or informative data such as reviews and ratings of the specific supplier.

However, providing a buyer with adequate and accurate information to make an informed decision regarding which supplier to transact with is a difficult process. First, the right data may not be available for a buyer to make an informed decision due to various issues such as obtaining rights to the data and normalizing the data across various formats. Second, critical buyer preferences and transactional requirements may not be taken into consideration when reviewing supplier performance. Third, historical transactional data between a specific buyer and specific supplier may not be considered. Fourth, data indicating the performance of a supplier may not be up-to-date, and thus, provide inaccurate information for buyers to base their decisions off.

For example, as part of a standard business cycle, the up-to-date performance of a supplier may fluctuate depending on a multitude of factors such as existing disputes, overages, and rejections with respect to buyers who are participating in ongoing transactions with the supplier. Thus, a supplier may be struggling to meet buyer satisfaction for current transactions even when historical data indicates that the supplier has a strong performance history. Additionally, buyer transactional requirements and preferences may contribute to faulty performance on part of the supplier. Thus, buyers may be misled into contracting with a troubled supplier that will inevitably result in sub-optimal transactional efficiency and less than desirable results.

Based on the foregoing, there is a need to provide more accurate information regarding supplier performance with respect to individual buyers.

### BRIEF DESCRIPTION OF THE DRAWINGS

FIG. 1 illustrates an example networked computer system in which various embodiments may be practiced.

FIG. 2 illustrates an example algorithm or method of providing supplier insights, according to various embodiments.

FIG. 3 illustrates an example algorithm or method of providing supplier insights with redress options, according to various embodiments.

FIG. 4 illustrates an example graphical user interface (GUI) for displaying the health score value of a particular supplier entity to a buyer.

FIG. 5 illustrates an example GUI for displaying dispute, overages, and rejection data records along with data regarding the status of electronic invoicing and catalogs with the subject supplier.

FIG. 6 illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Certain embodiments are described in the content of an application executing on a mobile computing device that works with a server computer. However, it is understood that an application is only executing code which may occur solely or partially on the mobile computing device. For example, the same principles as discussed in this application would be possible using a standalone computer, without access to a server computer.

Embodiments are described in sections according to the following outline:

1.0 GENERAL OVERVIEW

2.0 EXAMPLE NETWORKED COMPUTER SYSTEM

3.0 EXAMPLE ALGORITHMS AND METHODS

4.0 BENEFITS

5.0 HARDWARE OVERVIEW

6.0 OTHER ASPECTS OF DISCLOSURE

### 1.0 GENERAL OVERVIEW

Techniques and a system are provided for providing supplier insights with redress options. Based on external rating and profile data and internally generated transactional and rating data, a health score value for a supplier is calculated. In the event that the health score value has changed or is not above a threshold value, redress options are provided. For example, redress options include prohibiting a buyer from transacting with a particular supplier or recommending a suitable substitute supplier. Using these techniques, a health score value for a particular supplier can be calculated, and an appropriate action based on the health score value can be executed.

In one embodiment, a computer-implemented method comprises receiving, at a server computing instance, external rating data and profile data for a particular supplier entity of a plurality of supplier entities from one or more external data sources; storing, in one or more data repositories, supplier rating data values associated with the particular supplier entity, the supplier rating data values generated by a plurality of buyer entities who rated the particular supplier entity; storing, in one or more data repositories, first transactional information for the particular supplier entity, the first transactional information relating to past transactions between a particular buyer entity of the plurality of buyer entities and the particular supplier entity; storing, in one or more data repositories, second transactional information for the particular supplier entity, the second transactional information relating to past transactions between a plurality of buyer entities and the particular supplier entity; calculating a health score value for the particular supplier entity based at least in part on the external rating data and profile data for the particular supplier entity, the supplier rating data values associated with the particular supplier entity, and at least in part on comparing one or more metrics in the first transactional information to one or more metrics in the second transactional information; generating and causing displaying, at a computer associated with the buyer entity, a digital data display that indicates the health score value of the particular supplier entity. Other features, aspects and embodiments will become apparent from the disclosure as a whole including the drawings and claims.

### 2.0 EXAMPLE NETWORKED COMPUTER SYSTEM

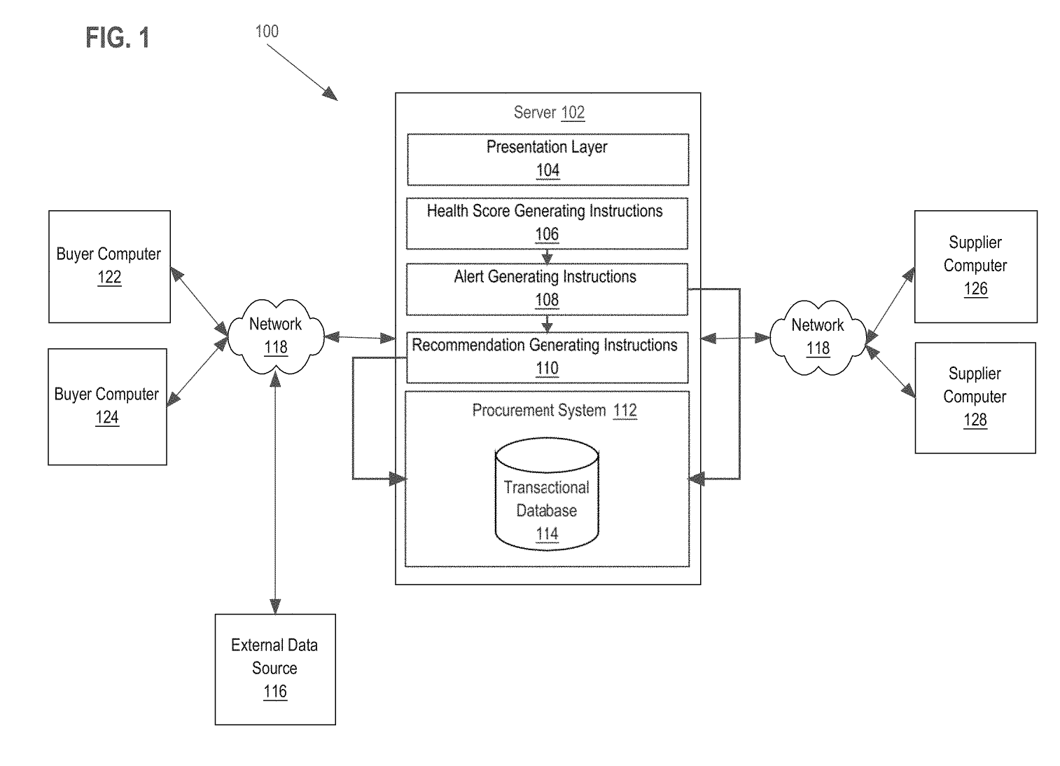

FIG. 1 is a block diagram of an example computer network system in which various embodiments may be practiced. FIG. 1 is shown in simplified, schematic format for purposes of illustrating a clear example and other embodiments may include other elements.

In an embodiment, a networked computer system 100 comprises a server computer (“server” for short) 102, buyer computers 122, 124, supplier computers 126, 128, an external data source 116, which are communicatively coupled directly or indirectly via network 118.

In an embodiment, the server computer 102 executes health score generating instructions 106, alert generating instructions 108, and recommendation generating instructions 110. The server 102 may also be executing additional code, such as code for a procurement system 112. Although the health score generating instructions 106, alert generating instructions 108, and recommendation generating instructions 110 are shown in FIG. 1 as executing on the server 102 separately from the procurement system 112, the health score generating instructions 106, alert generating instructions 108, and recommendation generating instructions 110 may be a part of computer instructions installed as part of the procurement system 112, as a module or a plug-in to supplement features of the procurement system 112, as a separate instance of executing code on the server 102 than an instance of code of the procurement system 112, or any other arrangement depending on the needs of a buyer entity.

The server 102 may generate and transmit alerts, notifications, recommendations and other information generated by the health score generating instructions 106, alert generating instructions 108, recommendation generating instructions 110, and procurement system 112 to the buyer computers 122, 124 and supplier computers 126, 128 over the network 118 via the presentation layer 116.

The procurement system 112 may include a transactional database 114 managed by the procurement system 112. The transactional database 114 may include transactional information on one or more supplier entities as well associated details on the supplier entities. The transactional database 114 may also include, for each supplier entity, one or more records of orders or transactions between the buyer entity and a respective supplier entity.

Although the transactional database is shown in FIG. 1 as encompassed by the procurement system 112, the transactional database 114 may exist separately from the procurement system 112 and/or server 102, and may be accessed via network 118.

Additional computing elements, code or other functional elements that are not shown in FIG. 1 may be provided by the procurement system 112.

The server 102 is accessible over a network 118 by multiple computing devices, such as supplier computer 126, supplier computer 128, buyer computer 122, and buyer computer 124. Although there are two supplier computers 126, 128 and two buyer computers 122, 124 shown in FIG. 1, any other number of supplier or buyer computers may be registered with the server 102 at any given time. Thus, the elements in FIG. 1 are intended to represent one workable embodiment but are not intended to constrain or limit the number of elements that could be used in other embodiments. In an embodiment, the buyer computer 122 and buyer computer 124 may be restricted to only buyers from a single buying entity. In other words, although more than one buyer computer may be used, only verified users of a single buying entity may access information stored in the procurement system 112 from these computers. Any applicable means of restricting unauthorized users from accessing the procurement system 112 may be used (for example, password and username, two-step authentication, or other means). Further, each of the supplier computer 126 and supplier computer 128 may correspond to one or more supplier entities. For example, the procurement system 112 is accessible by more than one supplier entity, because a buyer entity may choose to source from more than one supplier entity for one or more commodities. Different supplier entities may access the procurement system 112 concurrently or at different times, although information on one supplier entity may be hidden or inaccessible from other supplier entities.

The computing devices such as the buyer computers 122, 124 and supplier computers 126, 128 may comprise a desktop computer, laptop computer, tablet computer, smartphone, or any other type of computing device that allows access to the server 102.

The external data source 116 may be accessed via network 118 by the server 102. The external data source 116 may include information relating to one or more supplier entities as well associated details on the supplier entities. The data from the external data source 116 may be used as input to any of the health score generating instructions 106, alert generating instructions 108, recommendation generating instructions 110, and procurement system 112. Although there is one external data source 116 shown in FIG. 1, any other number of external data sources 116 may be accessed by the server at any given time.

The presentation layer 104 may be programmed or configured for generating electronic pages, alerts, notifications, hyperlinks, recommendations, or application protocol messages to output to the computing devices such as the buyer computers 122, 124 or supplier computers 126, 128. For example, the presentation layer 104 may be programmed to generate dynamic web pages that implement an application as a software-as-a-service (SaaS) application that the buyer computer 122, 124 or supplier computer 126, 128 accesses using a web browser hosted at the computing device.

The health score generating instructions 106 may be programmed or configured to generate a health score value for a supplier entity. For example, the health score generating instructions 106 may include features to access information from the transactional database 114 managed by the procurement system 112. The health score generating instructions 106 may also access the external data source 116 and transmit or receive data to and from the presentation layer 104, alert generating instructions 108, recommendation generating instructions 110, procurement system 112. The health score generating instructions 106 may also be used for implementing aspects of the flow diagrams that are further described herein.

The alert generating instructions 108 may be programmed or configured to generate alerts and notifications. For example, the alert generating instructions 108 may include features to communicate with the health score generating instructions 106, the recommendation generating instructions 110, the procurement system 112, and the presentation layer 104. The alert generating instructions 108 may also be used for implementing aspects of the flow diagrams that are further described herein.

The recommendation generating instructions 110 may be programmed or configured to generate recommendations for a buyer entity. For example, the recommendation generating instructions 110 may interact with the procurement system 112, including accessing the transactional database 114, and may also interact with the health score generating instructions 106, alert generating instructions 108, and the presentation layer 104. The recommendation generating instructions 110 may also be used for implementing aspects of the flow diagrams that are further described herein.

Network 118 may be implemented by any medium or mechanism that provides for the exchange of data between the various elements of FIG. 1. Examples of network 118 include, without limitation, a cellular network, communicatively coupled with a data connection to the computing devices over a cellular antenna, one or more Local Area Networks (LANs), one or more Wide Area Networks (WANs), one or more Ethernets or the Internet, or one or more terrestrial, satellite or wireless links, or a combination thereof. For purposes of illustrating a clear example, network 118 is shown as a single element but in practice, network 118 may comprise one or more local area networks, wide area networks, and/or internetworks. The various elements of FIG. 1 may also have direct (wired or wireless) communications links, depending upon a particular implementation.

### 3.0 METHOD OVERVIEW

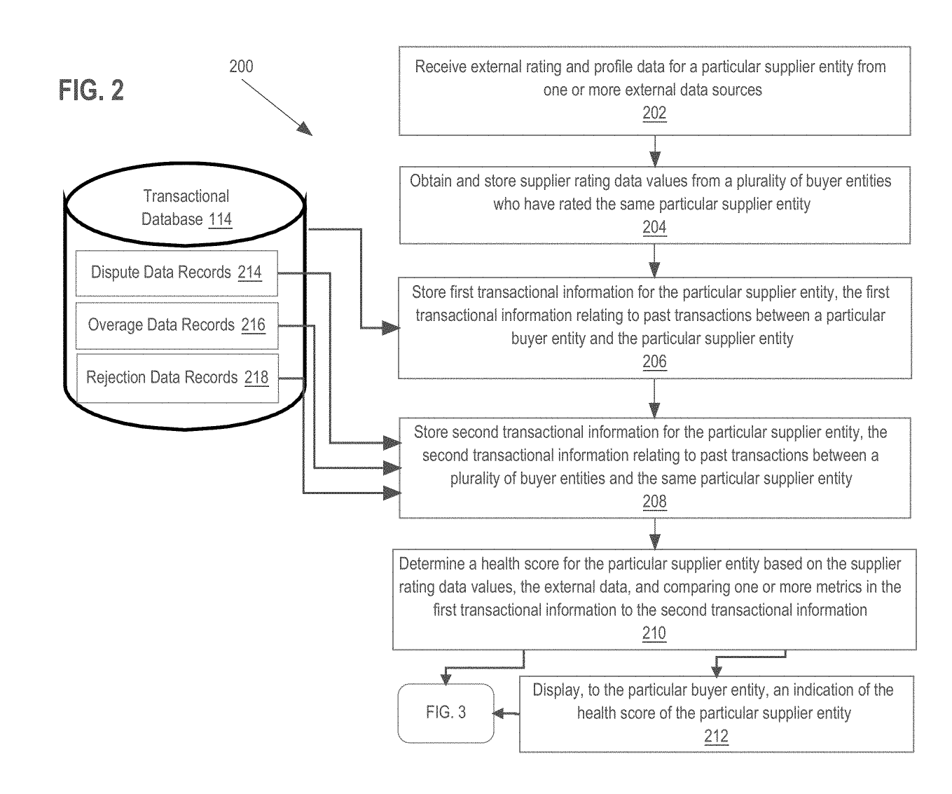

FIG. 2 is a flowchart of an example method of providing supplier insights with redress options, according to various embodiments.

For purposes of illustrating a clear example, FIG. 1 is described herein in the context of FIG. 1, but the broad principles of FIG. 2 can be applied to other systems having configurations other than as shown in FIG. 1. Further, FIG. 2 and each other flow diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 2 and each other flow diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

In step 202, data relating to a supplier entity is received from one or more external data sources. For example, the server 102 may query the external data source 116 via the network 118 for information relating to a particular supplier entity, and receive the data at the server 102 via the network 118. The data from the external data source 118 may be accessed through an application programming interface on part of a third-party information vendor such as Experian or Dun & Bradstreet. The data received by the server 102 from the external data 116 source may be stored temporarily or permanently at the server 102 for subsequent access by the system 100.

In an embodiment, the received information may include rating data for a particular supplier entity, profile data for a particular supplier entity, supplier analytics, demographic information for a particular supplier entity, and transactional information for a particular supplier. Rating data may include, without limitation, expressions of value attributed to the particular supplier entity by parties who have completed past transactions with the supplier entities. Profile data may include, without limitation, a name, address, a federal tax identification number, geolocation of the supplier, industry category of the supplier, types of commodities sold or being sold by the supplier.

In step 204, supplier rating data values are obtained from a plurality of buyer entities who have rated the same particular supplier entity. For example, supplier rating data values may be generated by buyer computers 122, 124 in response to a prompt for the buyer entity to rate a particular supplier entity. The rating data values may be transmitted via network 118 to the server 102, and stored in association with the e-procurement system 112 or in the transactional database 114.

In an embodiment, supplier rating data values may comprise a measure of buyer satisfaction for a particular supplier entity. Rating data may include, without limitation, expressions of value attributed to the particular supplier entity by parties who have completed past transactions with the supplier entities. For example, a rating data value may include 1-5 star rating that a buyer entity has submitted after engaging in a transaction with a particular supplier entity. A 5-star rating may indicate complete buyer satisfaction with the particular supplier, where a 1-star rating may indicate complete buyer dissatisfaction with the particular supplier. A single supplier entity may have multiple ratings from the same buyer entity and may have multiple ratings from a plurality of buyer entities. Multiple buyer ratings for a single supplier entity may be combined to form a composite rating value for the particular supplier entity.

In step 206, first transactional information relating to past transactions between a particular buyer entity and a particular supplier entity is stored. For example, a buyer entity using buyer computer 122, 124 may engage in a transaction with a particular supplier entity using the procurement system 112 via network 118. The buyer entity using a buyer computer 122, 124 may place an order through the procurement system 112 for commodities that the particular supplier entity is selling via the procurement system 112.

In an embodiment, throughout the existence of a transaction between a buyer entity and supplier entity, data records relating to the transaction may be stored. For example, data records associated with a transaction between a particular buyer entity using buyer computer 122, 124 and a particular supplier entity using supplier computer 126, 128 may be stored in the transactional database 114.

In some embodiments, the data records may include metrics such as dispute data records 214, overage data records 216, and rejection data records 218. Dispute data records may include data relating to disputes between supplier and buyer entities that occur throughout the procurement process. The dispute data may be specific to invoices that are disputed for a particular supplier or buyer. Overage data records may include data relating to overages that occur on invoices between supplier and buyer. An overage may indicate that the price on an invoice is above the price specified on a purchase order. A rejection data record may include data relating to purchase orders or invoices that are rejected in association with a supplier and/or buyer.

Other transactional data records stored in the transactional database 114 may include data indicating whether the commodities ordered by the particular buyer entity from the particular supplier entity were delivered on-time to the particular buyer entity, whether the quality of goods delivered to the particular buyer entity was as expected, or whether the original negotiated price was adhered to throughout the transaction.

In step 208, second transactional information relating to past transactions between a plurality of buyer entities and the same particular supplier entity is stored. For example, different buyer entities using buyer computers 122, 124 may engage in separate transactions with the same particular supplier entity using the procurement system 112. The buyer entities using buyer computers 122, 124 may place separate orders through the procurement system 112 for commodities that a particular supplier entity is supplying and the transactional data such as dispute data records 214, overage data records 216, and rejection data records 218 may be stored in the transactional database 114.

In an embodiment, the same type of transactional data records relating to transactions between a particular buyer entity and a particular supplier entity may be stored for each and every transaction that occurs between a buyer entity and a supplier entity. Thus, a supplier entity that engages in transactions with multiple buyer entities may accumulate a significant amount transactional data relating to past transactions that the particular supplier entity has engaged in.

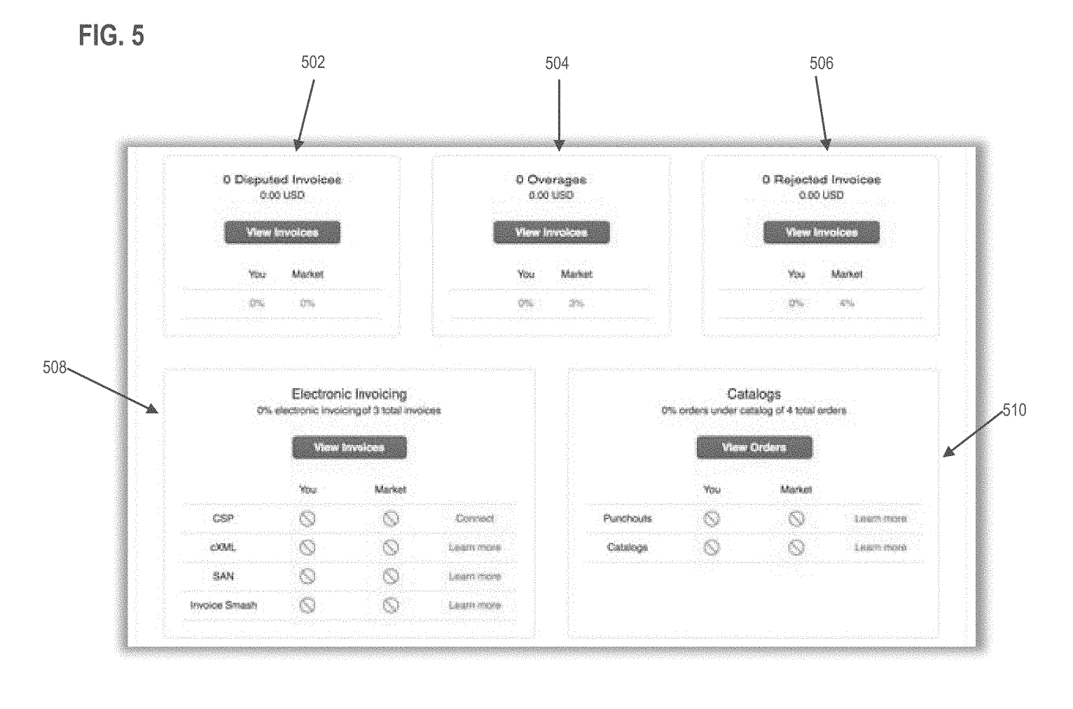

FIG. 5 depicts an example interface that displays dispute, overages, and rejection data records as well as data about the status of electronic invoicing and catalogs with the subject supplier.

Each section 502, 504, 506 shows the calculation of two values—a percentage value for the buyer based on transactional information relating to past transactions between the particular buyer and particular supplier, and the percentage value on average or based on transactional information relating to past transactions between a plurality of buyers and the same particular supplier. For example, in section 502, the value below “You” indicates the percentage of invoices that are disputed between the buyer and a particular supplier. The value below “Market” indicates the percentage of invoices that are disputed for the particular supplier among a plurality of other customers, users, accounts or enterprise that are collectively termed a larger “market”. Each “View Invoices” button links to the specific transactions to save the user time in investigating and verifying the calculated percentages.

Section 508 shows electronic invoicing metrics. Electronic invoicing metrics are indicators as to whether the supplier is transacting electronically with the customer locally, or with a customer community (denoted as the larger “market”) via each of the listed methods such as “CSP”, “cXML”, “SAN”, “Invoice Smash”. Values for display in section 508 may be obtained by programmatic calls to the database using a supplier ID as a key; in an embodiment, each supplier record includes flag values that specify whether CSP, cXML, SAN and InvoiceSmash invoicing has been enabled or is in use for the associated supplier and section 508 displays different icons depending on whether the retrieved values are TRUE or FALSE.

Section 510 shows the catalogs section. The catalogs section shows whether the supplier is loading catalogs electronically for a customer, and if not, whether they are loading catalogs electronically for other buyers in a larger network of buyers. This information can help the buyer obtain more catalog information electronically and improve transactional supplier performance. Values for display in section 510 may be obtained by programmatic calls to the database using a supplier ID as a key; in an embodiment, each supplier record includes flag values that specify whether punchouts or catalogs have been enabled or is in use for the associated supplier and section 510 displays different icons depending on whether the retrieved values are TRUE or FALSE.

In step 210, a health score value for a particular supplier entity is determined based on the data for a particular supplier entity received from one or more external data sources, supplier rating data values, and a comparison of one or more metrics in the first transactional information with one or more metrics in the second transactional information. For example, the health score generating instructions 106 may send a programmatic request to the procurement system 112 to obtain the required transactional data from the transactional database 114, such as the stored rating and profile data for a particular supplier entity that was originally received from the external data source, the stored supplier rating data values that are generated, the first transactional information for the particular supplier entity, and the second transactional information for the particular supplier entity. The health score generating instructions may also query the external data source 116 to receive the rating data and profile data values via network 118.

In an embodiment, a health score value may be calculated or determined programmatically by comparing the number of disputes, overages, and rejections associated with transactions between a particular supplier and particular buyer to the average disputes, overages, and rejections of the particular supplier. The average disputes, overages, and rejections of a particular supplier may be calculated by dividing a sum of the total number of disputes, overages, and rejections for a particular supplier across a plurality of buyers by a sum of the total number of buyers that the particular supplier has transacted with. For example, the number of disputes, overages, and rejections for a particular supplier may be retrieved from the transactional database 114, where the transactional database 114 includes records relating to disputes 214, overages 216, and rejections 218.

In an embodiment, if the number of disputes, overages, and rejections for a particular supplier in association with a particular buyer is less than the average disputes, overages, and rejections for the particular supplier in association with a plurality of buyers, then the supplier is given a positive performance rating factor. The positive performance rating factor may move a supplier into the best health category in relation to the specific buyer.

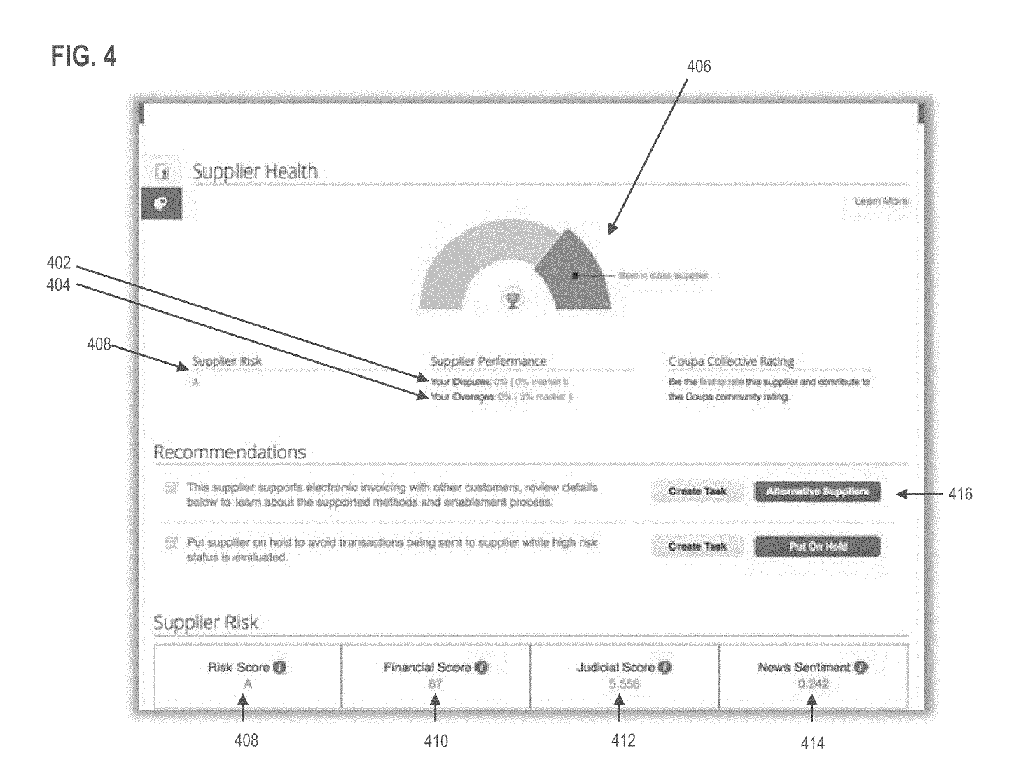

In an embodiment, a health score value may indicate supplier risk, such as how likely a particular supplier entity is to go out of business. A health score value may also indicate different risk factors including financial, compliance, legal, environmental, and corporate or social responsibility. As shown in FIG. 4, supplier risk may include a risk score 408, a financial score 410, a judicial score 412, and a news sentiment 414.

In another embodiment, a health score value for a particular supplier entity may be determined based on a comparison of one or more metrics in the first transactional information with one or more metrics in the second transactional information.

In another embodiment, because the first transactional information includes information relating to past transactions between a particular buyer entity and a particular supplier entity and the second transactional information includes information relating to past transactions between a plurality of buyer entities and the same particular supplier entity, the determined health score value for the particular supplier entity may indicate a different health score value to each different buyer entity. For example, if the transactional data relating to the particular supplier entity indicates a high dispute rate with a particular buyer entity but low dispute rate with a plurality of buyer entities, then the particular buyer entity may be above the risk benchmark for that particular supplier entity. In this scenario, the health score value for a particular supplier entity may be represented by a value that indicates a high risk to that particular buyer entity, where the health score value for the same particular supplier entity may be represented by a value that indicates an average or low risk for a different buyer entity that has no history of disputes with the particular supplier entity.

In another embodiment, the factors used in determining a health score value may be weighted. For example, a buyer entity may indicate their own personal rating preferences and the health score value for a supplier entity may be modified accordingly. For example, a particular buyer entity may choose to weigh the supplier rating data values higher than the rating data and profile data for a particular supplier entity that were received from an external data source. In another example, a particular buyer entity may choose to weigh the second transactional information higher than the first transactional information.

In step 212, an indication of the health score value of a particular supplier entity is displayed to the particular buyer entity. For example, the health score value may be determined by the health score generating instructions 106 and transmitted by the presentation layer 104 via the network 118 to a buyer computer 122, 124 where the health score value is displayed.

In an embodiment, an indication of the health score value may be displayed in a numerical format, graphical representation, or any combination thereof.

In an embodiment, when the health score value for a particular supplier is below a threshold value, the buyer may be prohibited from engaging in a transaction with the particular supplier. For example, once the health score value is determined by the health score generating instructions 106, the procurement system 112 may prohibit a buyer computer 122, 124 from transacting with the particular supplier. The threshold health score value may be specified by a default system value or may be specified by the buyer. Specifically, if the health score value for a particular supplier is below the threshold, the procurement system 112 may prohibit the entry of a purchase order by the buyer that identifies the particular supplier as a party to the transaction. A notification may be generated by the alert generating instructions 108 and presented to the buyer via the presentation layer 104 that informs that buyer that the attempted transaction with the particular supplier is prohibited.

In an embodiment, if the buyer is prohibited from engaging in a transaction with the particular supplier, the buyer may be restricted to only be allowed to transact with a suitable substitute supplier. For example, once the health score value is determined by the health score generating instructions 106, the procurement system 112 may prohibit a buyer computer 122, 124 from transacting with the particular supplier. The procurement system 112 may provide recommendations for suitable substitute suppliers, as described herein, and only allow the buyer to transact with recommended substitute suppliers. The restrictions may be commodity based, in that the restrictions placed on the buyer will only apply to specific transactions with suppliers where a particular commodity has been identified as the cause of the below-threshold health score value.

FIG. 4 depicts an example interface for displaying the health score value of a particular supplier entity to a buyer.

In the example interface, 406 shows a graphical representation of the current supplier health score value, which is computed by the processes and methods described herein. Supplier performance calculations are also displayed. For example, 402 indicates the percentage of invoices that are disputed for this supplier locally for a customer and also a calculation of the same numbers for this supplier, but averaged across the market. 404 indicates the percent of overages, on average, that invoices are above purchase orders locally for a customer and also a calculation of the same numbers for the particular supplier, but averaged across the market. Comparing the local and global percentages allows the buyer to know if the supplier is performing better for the buyer than on average, and also whether on average they are a poor performer. A poor performer may indicate that the particular supplier has higher disputes and overages which means they may cost buyers more time and processing, or more money than expected. Both of these indications can impact the overall health score value of a supplier.

FIG. 4 also shows supplier risk factors. Supplier risk factors may include a risk score 408, a financial score 410, a judicial score 412, and a news sentiment 414.

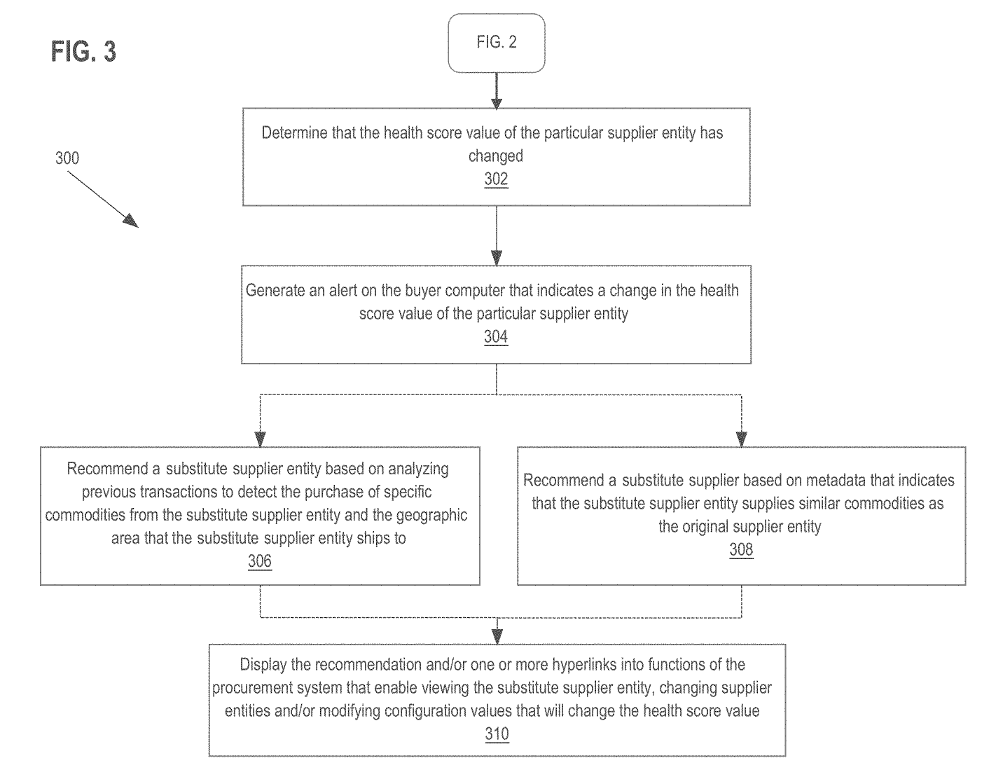

Referring now to FIG. 3, flow 300 shows the continuation of flow 200 from FIG. 2.

In step 302, once a health score value has been determined for a particular supplier entity, it is determined that the health score value of the particular supplier entity has changed. For example, the health score generating instructions 106 may determine a new health score value for a particular supplier entity, as discussed in step 210, other than the health score value that was previously determined.

In an embodiment, any change to the data that is used to determine a health score value may cause a change in the health score value itself. For example, a change in the health score value of a particular supplier entity may be based on a change in the transactional data stored in the transactional database 114 or an update to the data stored in the external data source 116. In another embodiment, a change in the health score value for a particular supplier entity may be caused by a change in weighting preferences by the particular buyer entity.

In step 304, an alert is generated that indicates a change in the health score value of the particular supplier entity. For example, the server 102 generates alerts or notifications via the alert generating instructions 108 and sends the alerts or notifications via the presentation layer 104 over the network 118 to the buyer computer 122, 124. Based on the health score value generated by step 210 and detection of the change in the health score value by step 302, the alerts or notifications are sent to the buyer computer 122, 123 that is associated with the change in the health score value. In an embodiment, the alerts or notifications may prompt the buyer entities via the buyer computers 122, 124 to enter additional information.

In step 306 and step 308, a substitute supplier entity is recommended based on determining that the health score value of the particular supplier entity has changed. For example, the recommendation generating instructions 110 may generate recommendations for substitute supplier entities based on various factors and send the recommendations via the presentation layer 104 over the network 118 to the buyer computers 122, 124.

As shown in FIG. 4, a link to alternative suppliers 416 may be provided by a user interface to allow the user to easily view alternative supplier recommendations.

In one embodiment, the factors used by the recommendation generating instructions 110 to recommend substitute supplier entities may include: detecting, based on supplier metadata, that a substitute supplier entity supplies similar commodities as the original supplier entity, analyzing supplier transactions to detect the purchase of specific commodities from the substitute supplier entity, and analyzing supplier transactions to determine the shipping range of a substitute supplier entity. Supplier metadata may include, without limitation, a federal tax identification number, geolocation of the supplier, industry category of the supplier, item descriptions, types or categories of commodities being sold by the supplier, and/or types or categories of commodities previously sold by the supplier. The metadata may be generated and stored internally by the system or may be received from an external source. For example, supplier metadata may be retrieved from purchase orders or invoices associated with the particular supplier.

For example, if it is detected, based on supplier metadata, that a particular supplier entity is selling commodities similar to those of the original supplier entity for which the health score value has changed, the particular supplier entity that sells similar commodities may be determined to be a suitable substitute supplier entity for the particular buyer entity.

In another example, if it is determined, based on transactional data, that buyer entities have purchased commodities from a supplier entity that may serve as suitable substitutes to the commodities offered by the original supplier entity, the particular supplier entity that sells the similar commodities may be determined to be a suitable substitute supplier entity for the particular buyer entity.

In an embodiment, supplier metadata for the particular supplier entity may be analyzed to determine which categories of commodities are sold by the supplier. For example, analysis may comprise forming a database query that retrieves records of all transactions for one or more (Q) calendar quarters, then sorting the result set of records based on a commodity identifier as a sorting key value, then ranking the transactions by counts of particular commodity identifiers to identify the top N commodities (or all commodities) that the supplier sold during Q. Similar query, filter and sort techniques may be used to determine amounts sold. Other supplier entities may be analyzed in the same manner to determine which categories of commodities are sold for each respective supplier. The resulting values can be compared programmatically to identify a number S of suppliers that have similar categories and levels of spending, within a level L of tolerance, such as within 20% of some other range. For example a supplier S₁ that has 7 of 10 of the same commodities as supplier S₂ and has sales for those commodities in a total that is within 20% of supplier S₂ may result in a determination that supplier S₁ is similar to supplier S₂. Supplier entities that have matching categories of spend as the particular supplier entity may be presented to the buyer as suitable substitute supplier entities. All such calculations, tests, determinations and presentations are implemented using programmed instructions.

In an embodiment, supplier metadata for the particular supplier entity may be analyzed to determine item descriptions of commodities that are sold by the particular supplier. The item descriptions associated with the particular supplier entity may be matched to item descriptions associated with other supplier entities. For example, item descriptions associated with other supplier entities may be received from external sources via network 118, or may be stored as metadata at the procurement system 112. Supplier entities that are associated with item descriptions that match the item descriptions associated with the particular supplier entity may be presented to the buyer as suitable substitute supplier entities.

In an embodiment, once the item descriptions are determined, the item descriptions may be associated with a standardized category. The standardized categories associated with the particular supplier may be matched to standardized categories associated with other supplier entities. Other supplier entities associated with standardized categories that match the standardized categories associated with the particular supplier entity may be presented to the buyer as suitable substitute supplier entities.

In another example, if it is determined, based on transactional data, that a particular buyer entity's shipping address is within the geographic area that a particular supplier entity has shipped or currently ships commodities to, the particular supplier entity may be determined to be a suitable substitute supplier entity for the particular buyer entity. Any combination of these specific factors may be suitable to determine and recommend a substitute supplier entity.

In an embodiment, if a substitute supplier entity is recommended based on determining that the health score value of the particular supplier entity has changed, the buyer may be prohibited from transacting with each supplier entity of the plurality of supplier entities who is not the substitute supplier entity. For example, once the procurement system 112 identifies that a health score value has changed and a substitute supplier has been recommended by the recommendation generating instructions 110, the procurement system 112 may prohibit a buyer from engaging in a transaction with any supplier who is not determined to be a substitute supplier.

In step 310, the recommendation for the substitute supplier entity is displayed to the buyer entity. In addition to the recommendation, the buyer display may include one or more hyperlinks into functions of the procurement system 112 that enable viewing the substitute supplier, functionality that enables changing suppliers, and functionality that enables the modification of configuration values that change the health score value of a particular supplier entity. For example, the recommendation for a substitute supplier entity may be determined by the recommendation generating instructions 110 and transmitted by the presentation layer 104 via the network 118 to a buyer computer 122, 124 where the recommendation for the substitute supplier is displayed. The buyer entity may interact with the display at the buyer computer 122, 124 to view information relating to the recommended substitute supplier entity, change supplier entities based on the recommendation, or modify configuration values that change the health score value of a particular supplier entity.

### 4.0 BENEFITS

Using these approaches, data indicating the overall risk of doing business with a supplier can be leveraged by a computing system to optimize resource allocation and usage. A core competency of a system that services the above described invention is to facilitate transactions between buyers and suppliers. The ideal transaction involves a successfully placed order and a successfully delivered order without a dispute, overage, or rejection. The goal of this invention is to optimize the system so that the above discussed best-case scenario is almost always achieved. This ensures that the consumers are operating in the most efficient way possible in the business environment and also allows the system to run closer to peak efficiency.

For example, in a transaction between and buyer and supplier, if a dispute occurs, numerous computational resources such as CPU cycles, memory, storage, and network bandwidth are dedicated to both the buyer and supplier so that each of them are provided with the adequate data and resources needed in order to bring a resolution to the dispute and continue or discontinue the transaction. In a transaction without a dispute, overage, or rejection, less computational resources are spent dealing with issues such as disputes, overages, rejections. Instead, using the techniques described in this paper, disputes, overages, and rejections can be avoided entirely, ensuring that the computational resources of the system that would normally be devoted to resolving disputes are preserved.

### 5.0 HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

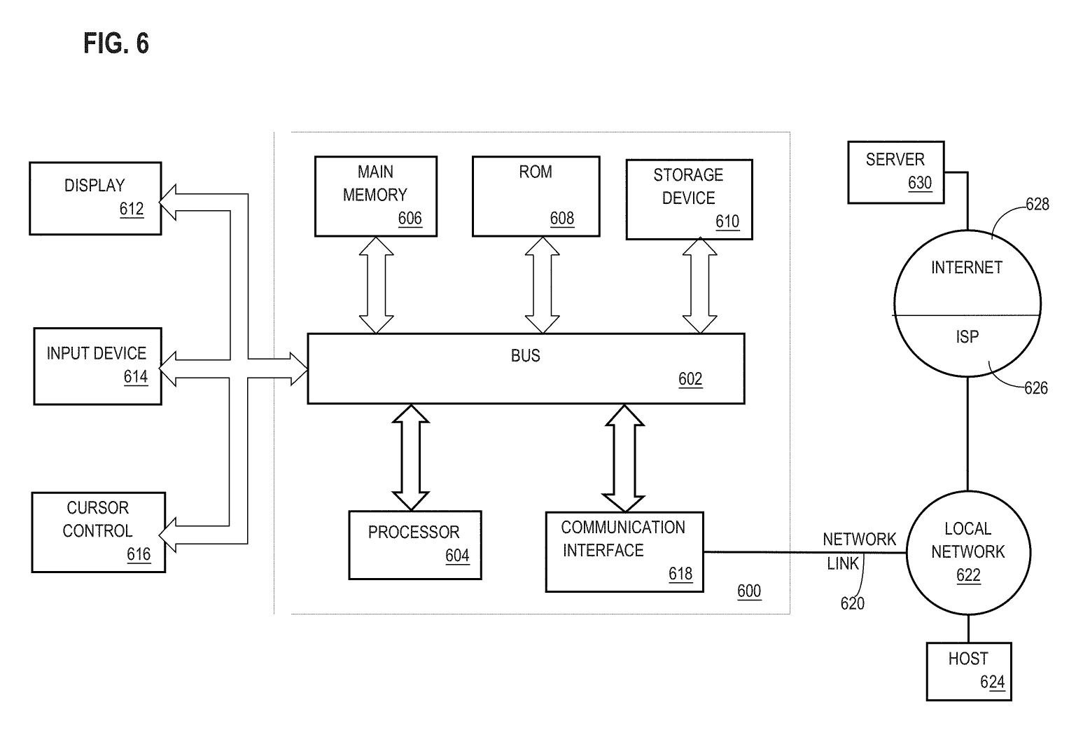

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 402 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

### 6.0 OTHER ASPECTS OF DISCLOSURE

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A computer-implemented method comprising:
receiving, at a server computing instance, external rating data and profile data for a particular supplier entity of a plurality of supplier entities from one or more external data sources;
storing, in one or more data repositories, supplier rating data values associated with the particular supplier entity, the supplier rating data values generated by a plurality of buyer entities who rated the particular supplier entity;
storing, in one or more data repositories, first transactional information for the particular supplier entity, the first transactional information relating to past transactions between a particular buyer entity of the plurality of buyer entities and the particular supplier entity;
storing, in one or more data repositories, second transactional information for the particular supplier entity, the second transactional information relating to past transactions between a plurality of buyer entities and the particular supplier entity;
calculating a health score value for the particular supplier entity based at least in part on the external rating data and profile data for the particular supplier entity, the supplier rating data values associated with the particular supplier entity, and at least in part on comparing one or more metrics in the first transactional information to one or more metrics in the second transactional information;
generating and causing displaying, at a computer associated with the buyer entity, a digital data display that indicates the health score value of the particular supplier entity.

2. The method of claim 1 wherein the rating data values represent expressions of value attributed to the particular supplier entity by parties who have completed past transactions with the supplier entities;
wherein the profile data represents, for a particular supplier entity, a name, address, a federal tax identification number, geolocation, industry category, or types of commodities sold.

3. The method of claim 1, wherein the first and second transactional information includes dispute data records, overage data records, and rejection data records.

4. The method of claim 1, further comprising generating, based on determining that the health score value of the particular supplier entity has changed, a notification on a computer associated with the buyer entity that indicates a change in the health score value of a particular supplier entity.

5. The method of claim 1, further comprising identifying that the health score value for the particular supplier entity is below a threshold health score value;
in response to identifying that the health score value for the particular supplier entity is below the threshold health score value, prohibiting the particular buyer entity from transacting with the particular supplier entity.

6. The method of claim 1, further comprising generating and submitting a database query to a digital data repository, based on determining that the health score value of the particular supplier entity has changed, and receiving a record for a substitute supplier entity from the plurality supplier entities, the substitute supplier entity having a health score value that is better than the health score value of the particular supplier entity.

7. The method of claim 6, wherein the selecting a substitute supplier entity from the plurality supplier entities in the database is based on metadata associated with supplier entity records that indicate that the substitute supplier entity supplies similar commodities as the particular supplier entity.

8. The method of claim 6, wherein the selecting a substitute supplier entity from the plurality supplier entities is based on analyzing transactional information to detect that the substitute supplier entity offers commodities that are similar to the commodities offered by the particular supplier entity and a geographic area that the substitute supplier entity delivers commodities to.

9. The method of claim 6, further comprising generating and causing displaying, at a computer associated with the buyer entity, a digital data display that indicates a recommendation for the substitute supplier entity.

10. The method of claim 6, further comprising generating and causing displaying, at a computer associated with the buyer entity, a digital data display that includes one or more hyperlinks into functions of a procurement system that enable viewing the substitute supplier entity or changing supplier entities.

11. The method of claim 6, further comprising generating and causing displaying, at a computer associated with the buyer entity, a digital data display that includes one or more hyperlinks into functions of a procurement system that enable modifying configuration values that change the health score value of the particular supplier entity.

12. The method of claim 6, further comprising prohibiting the particular buyer entity from transacting with each supplier entity of the plurality of supplier entities who is not the substitute supplier entity.
